(19) United States
(12) Patent Application Publication
(10) Pub. No.: US 2010/0082935 A1
(43) Pub. Date: Apr. 1, 2010

(54) COMPUTER SYSTEM AND CAPACITY MANAGEMENT METHOD OF COMPUTER SYSTEM

(75) Inventors: Toru TANAKA, Kawasaki (JP); Yuichi TAGUCHI, Sagamihara (JP); Noriko NAKAJIMA, Machida (JP)

Correspondence Address: BRUNDIDGE & STANGER, P.C., 1700 DIAGONAL ROAD, SUITE 330, ALEXANDRIA, VA, 22314, US

(73) Assignee: Hitachi, Ltd.

(21) Appl. No.: 12/324,909

(22) Filed: Nov. 28, 2008

(30) Foreign Application Priority Data
Sep. 30, 2008 (JP) 2008-252092

(51) Int. Cl. G06F 12/02; G06F 12/00

(52) U.S. Cl. 711/171; 711/170

(57) ABSTRACT

It is necessary to install a program called an agent in order to keep track of how much a file system on a computer uses a disk. On this account, loads might be applied to a server due to installation work or the agent program to increase primary costs. In addition, software inside a storage device determines and records a target block for data input/output and keeps track of capacity utilization, which might degrade the input/output performance of the storage device. A computer system is provided in which configuration information and operating information are acquired from a storage device, when data input/output is made from a computer to a logical unit, it is determined that the computer uses the logical unit to which input/output is made, and capacity used by the computer is computed.

### CROSS REFERENCES TO RELATED APPLICATIONS

This application relates to and claims priority from Japanese Patent Application No. 2008-252092, filed on Sep. 30, 2008, the entire disclosure of which is incorporated herein by reference.

### BACKGROUND OF THE INVENTION

1. Field of the Invention

The present invention relates to a capacity management method of a storage system.

2. Description of the Related Art

In recent years, data volume handled on a computer is increasing because of the improvements in performance of a computer and in speed of Internet lines. Particularly, in a thin client system in which mail boxes in a mail system and OS images used by users are stored in storages, data volume tends to be affected by an increase in the number of users. The introduction of storages having a suitable capacity to increasing data volume raises expectation for TCO reduction, for example. To this end, software (see Patent Reference 1 (JP-A-2004-139494)) and a technique (see Patent Reference 2 (JP-A-2003-303054)) are disclosed for managing the capacity used by computers. In addition, a technique that remotely manages an IT system including storage devices is disclosed (see Patent Reference 3 (U.S. patent publication No. 2002/0271656 A1)).

### SUMMARY OF THE INVENTION

However, according to the technique described in Patent Reference 1, in order to keep track of how large volume a file system on a computer occupies on a disk, it is necessary to install a program called an agent in the computer. On this account, installation work or the agent program might apply loads to a server to increase primary costs. In the case in which there is a plurality of computers, a plurality of the computers individually manages the capacity. Because of this, in order to send and receive administrative information about capacity over networks by a management program, it is necessary to individually authorize the computers, and an agent program is generally used for management. Also in the case in which a computer has a plurality of virtual file systems, an agent program is necessary because of the similar reasons. In addition, according to the technique described in Patent Reference 2, because it is necessary that software in a storage device determines and records a target block for data input/output, the input/output performance of the storage device might be degraded. In addition, in Patent Reference 3, although the capacity of a physical disk can be kept track of from configuration information of a storage device, it is unable to keep track of the disk capacity used by a computer.

The invention has been made in the light of the circumstances. An object is to provide a technique that manages the disk capacity used by a computer with no installation of a program into the computer.

A computer system is provided in which configuration information and operating information are acquired from a storage device, when data input/output is made from a computer to an LU (Logical Unit), it is determined that the computer uses the LU to which input/output is made, and capacity used by the computer is computed.

An advantage according to the invention is that disk capacity can be managed without applying loads to a server due to installation work or an agent program.

### BRIEF DESCRIPTION OF THE DRAWINGS

The teachings of the invention can be readily understood by considering the following detailed description in conjunction with the accompanying drawings, in which:

FIG. 1 shows a diagram illustrative of a system configuration according to an embodiment of the invention;

FIG. 2 shows a diagram illustrative of the memory configuration of a computer according to an embodiment of the invention;

FIG. 3 shows a diagram illustrative of the memory configuration of a management computer according to an embodiment of the invention;

FIG. 4 shows a diagram illustrative of the memory configuration of a storage device according to an embodiment of the invention;

FIG. 5 shows a diagram illustrative of a computer configuration table according to an embodiment of the invention;

FIG. 6 shows a diagram illustrative of a capacity determination configuration table according to an embodiment of the invention;

FIG. 7 shows a diagram illustrative of a the LU status management table according to an embodiment of the invention;

FIG. 8 shows a diagram illustrative of a storage device configuration information table according to an embodiment of the invention;

FIG. 9 shows a diagram illustrative of a storage device operating information table according to an embodiment of the invention;

FIG. 10 shows a diagram illustrative of a storage device configuration history table according to an embodiment of the invention;

FIG. 11 shows a diagram illustrative of a capacity determination process according to an embodiment of the invention;

FIG. 12 shows a diagram illustrative of a capacity utilization computation process according to an embodiment of the invention;

FIG. 13 shows a diagram illustrative of a nontarget data exclusion process according to an embodiment of the invention;

FIG. 14 shows a diagram illustrative of an LU status determination process according to an embodiment of the invention;

FIG. 15 shows a diagram illustrative of a capacity utilization management screen according to an embodiment of the invention;

FIG. 16 shows a diagram illustrative of a system configuration according to an embodiment of the invention;

FIG. 17 shows a diagram illustrative of a capacity determination process according to an embodiment of the invention; and

FIG. 18 shows a diagram illustrative of the memory configuration of a storage device according to an embodiment of the invention.

### DETAILED DESCRIPTION OF THE INVENTION

Hereinafter, embodiments of the invention will be described in detail.

### Embodiment 1

The outline of an embodiment of the invention will be described. The invention is conducted when the capacity of a storage device 1400 used by a computer 1000 is computed.

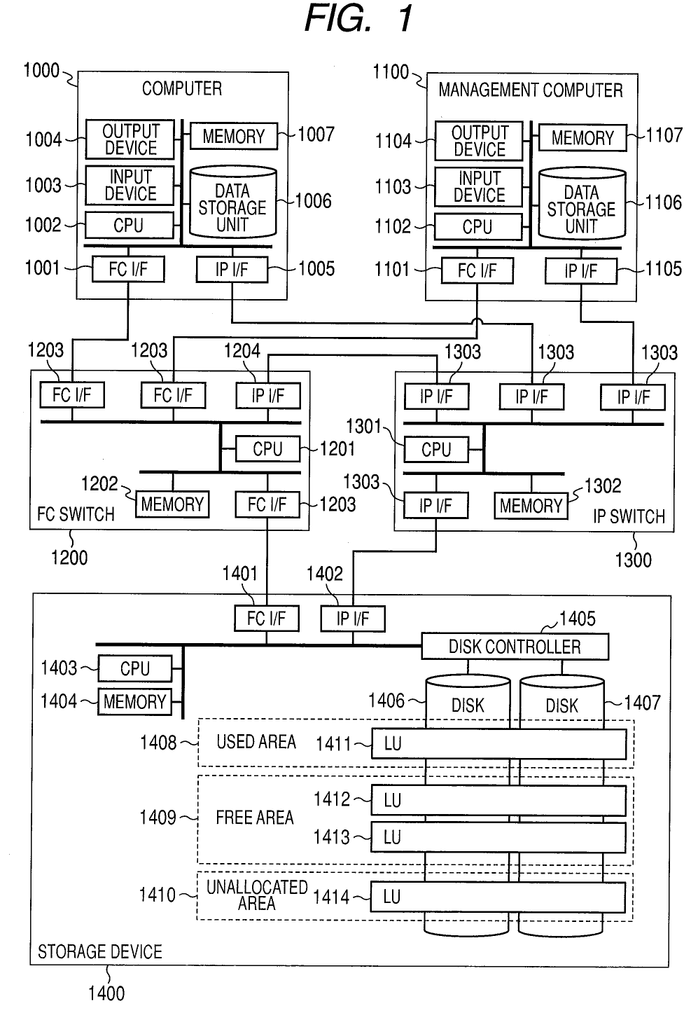

FIG. 1 shows a system configuration according to an embodiment of the invention. In FIG. 1, the computer 1000 is a computer that performs data input/output to the storage device 1400. In FIG. 1, although only a single computer 1000 is shown, the computer 1000 may be plural. In addition, the computer 1000 may have a plurality of virtual file systems.

The computer 1000 has an FC I/F (fibre channel interface) 1001, an IP I/F (Internet Protocol interface) 1005, a CPU (central processing unit) 1002, a memory 1007, a data storage unit 1006, an input unit 1003, and an output unit 1004.

The FC I/F 1001 sends and receives input/output data with the storage device 1400. The IP I/F 1005 sends and receives management data with a management computer 1100. The CPU 1002 runs programs to control the overall computer. The memory 1007 is a data storage area for programs. The data storage unit 1006 stores therein programs and user data. The input unit 1003 is a device such as a keyboard and a mouse through which a user inputs data. The output unit 1004 is a device such as a display device on which information for a user is displayed.

The management computer 1100 is a computer that manages the computer 1000 and the storage device 1400. The management computer 1100 has an FC I/F 1101, an IP I/F 1105, a CPU 1102, a memory 1107, a data storage unit 1106, an input unit 1103, and an output unit 1104.

The FC I/F 1101 sends and receives input/output data and control data with the storage device 1400. The IP I/F 1105 sends and receives management data with the computer 1000 and the storage device 1400. The CPU 1102 runs programs to control the overall computer. The memory 1107 is a data storage area for programs. The data storage unit 1106 stores therein programs and user data. The input unit 1103 is a device such as a keyboard and a mouse through which a user inputs data. The output unit 1104 is a device such as a display device on which information for a user is displayed.

The FC switch (fibre channel switch) 1200 is a switching device that transfers input/output data from the management computer 1000 to the storage device 1400. The FC switch 1200 has an FC I/F 1203, an IP I/F 1204, a CPU 1201, and a memory 1202.

The FC I/F 1203 sends and receives input/output data. The IP I/F 1204 sends and receives management data. The CPU 1201 runs programs to control the overall FC switch. The memory 1202 is a data storage area for programs and data.

An IP switch 1300 is a switching device that transfers management data from the management computer 1100 to the computer 1000. The IP switch 1300 has an IP I/F 1303, a CPU 1301, and a memory 1302.

The IP I/F 1303 sends and receives management data. The CPU 1301 runs programs to control the overall IP switch. The memory 1302 is a data storage area for programs and data.

The storage device 1400 is a node that processes input/output data from the computer 1000. The storage device 1400 has an FC I/F 1401, an IP I/F 1402, a CPU 1403, a memory 1404, a disk controller 1405, disk devices 1406 and 1407, LUs 1411 to 1414, a used area 1408, a free area 1409, and an unallocated area 1410.

The FC I/F 1401 receives input/output data transferred from the FC switch. The IP I/F 1402 receives management data from the management computer 1100. The CPU 1403 runs programs to control the overall storage device. The memory 1404 is a data storage area for programs. The disk controller 1405 controls access to the disks according to directions from the CPU 1403. The disk devices 1406 and 1407 store thereon user data. The LUs 1411 to 1414 are a data storage area allocated to use the disk device by the computer 1000. The used area 1408 is the LU allocated to the computer 1000 and used by the computer 1000. The free area 1409 is the LU that is allocated to the computer 1000 but not used by the computer 1000. The unallocated area 1410 is the LU not allocated to the computer 1000.

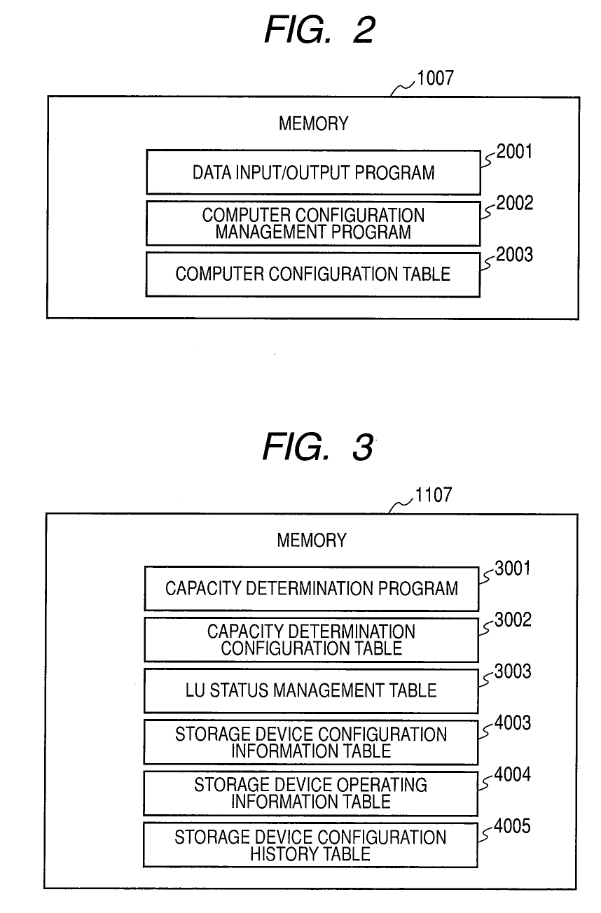

FIG. 2 shows the memory configuration of the computer 1000. The computer 1000 reads a data input/output program 2001, a computer configuration management program 2002, and a computer configuration table 2003 to the memory 1007 when started.

The data input/output program 2001 is a program that performs data input/output to the storage device 1400. The computer configuration management program 2002 is a program that manages configuration information of the computer. The computer configuration table 2003 keeps information about the LU used by the computer and the I/F that connects to the used LU.

FIG. 3 shows the memory configuration of the management computer 1100. The management computer 1100 reads the capacity determination program 3001, the capacity determination configuration table 3002, an LU status management table 3003, a storage device configuration information table 4003, a storage device operating information table 4004, and a storage device configuration history table 4005 to the memory 1107 when started.

The capacity determination program 3001 is a program that determines the capacity of the storage device 1400 used by the computer 1000. The capacity determination configuration table 3002 is a table that configures the conditions of determining the capacity of the storage device 1400. The LU status management table 3003 keeps information whether the LU of the storage device 1400 used by the computer 1000 is allocated or not and used or not. The storage device configuration information table 4003 keeps the configuration information of the storage device 1400. The storage device operating information table 4004 keeps information about IOPS (Input/Output Per Second) that is inputs and outputs per second to the LUs included in the storage device 1400. The storage device configuration history table 4005 keeps information about the date and time at which the LUs included in the storage device 1400 are created and the date and time at which the LU is allocated to a port.

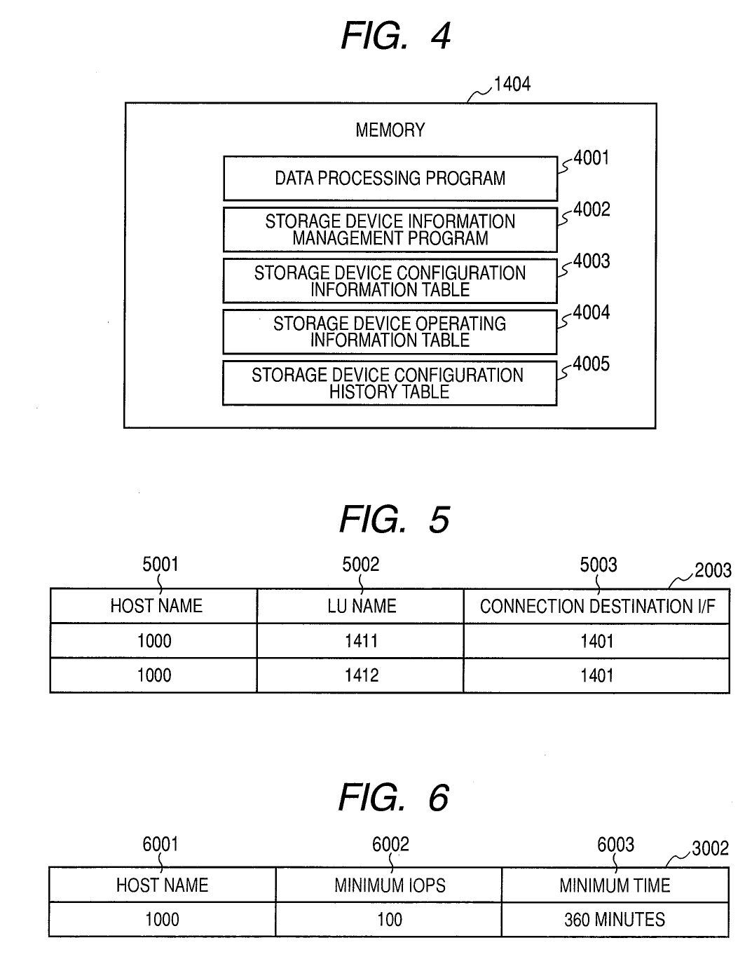

FIG. 4 shows the memory configuration of the storage device 1400. The storage device 1400 reads a data processing program 4001, a storage device information management program 4002, a storage device configuration information table 4003, a storage device operating information table 4004, and a storage device configuration history table 4005 to the memory 1404 when started.

The data processing program 4001 is a program that processes access from the computer 1000 to the storage device 1400. The storage device information management program 4002 is a program that manages the configuration information, operating information and configuration history of the storage device 1400. In addition, the storage device information management program 4002 sends these items of information in response to a request from the management computer 1100. The storage device configuration information table 4003, the storage device operating information table 4004, and the storage device configuration history table 4005 are similar to those described in FIG. 3.

FIG. 5 shows the configuration of the computer configuration table 2003. The computer configuration table 2003 has a host name 5001, an LU name 5002, and a connection destination I/F 5003.

The host name 5001 is an identifier used to look for the computer. The LU name 5002 is an identifier of the LU used by the computer. The connection destination I/F 5003 is a connection destination of the LU used by the computer.

FIG. 6 shows the configuration of the capacity determination configuration table 3002. The capacity determination configuration table 3002 has a host name 6001, a minimum IOPS 6002, and a minimum time 6003.

The host name 6001 is an identifier of the computer. The minimum IOPS 6002 is a minimum amount of inputs/outputs per second, which is used to determine that an LU is used. In the case in which an amount of inputs/outputs exceeds the minimum IOPS 6002, it is determined that the LU is used. Even though the computer inputs and outputs no data, a certain amount of inputs/outputs is generated by monitoring the server or the storage itself. IOPS is measured in the state in which the computer inputs and outputs no data, and the value is inputted to the minimum IOPS 6002. The minimum time 6003 is the time after creation of the LU, which is used to determine that the LU is used. When the time after creation of the LU exceeds the minimum time 6003, it is determined that the LU is used. Inputs/outputs are sometimes generated for a certain period because of data migration or formation. A time period during which inputs/outputs are generated in data migration or formation is measured, and the value is inputted to the minimum time 6003.

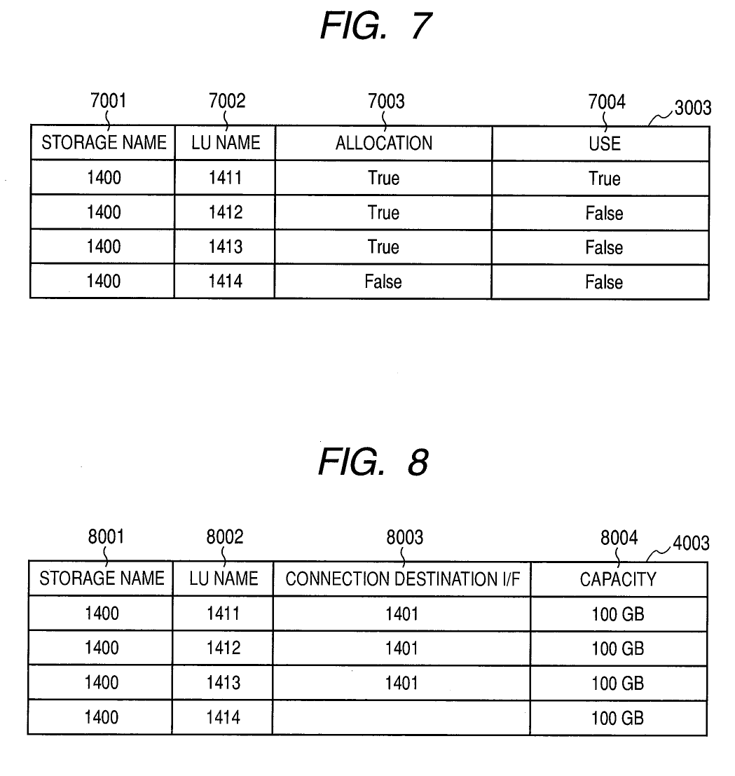

FIG. 7 shows the configuration of the LU status management table 3003. The LU status management table 3003 has a storage name 7001, an LU name 7002, an allocation 7003, and a use 7004.

The storage name 7001 is an identifier of the storage device. The LU name 7002 is an identifier of the LU. The allocation 7003 indicates whether the LU is allocated to the computer. When the LU is allocated to a port, the indication of the allocation 7003 is “True”. The use 7004 indicates whether the LU is used by the computer. When a disk is additionally installed, LUs are created, and storage names 7001 and LU names 7002 are added. At this time, the indications of the allocation 7003 and the use 7004 are “False”.

FIG. 8 shows the configuration of the storage device configuration information table 4003. The storage device configuration information table 4003 has a storage name 8001, an LU name 8002, a connection destination I/F 8003, and a capacity 8004.

The storage name 8001 is an identifier of the storage device. The LU name 8002 is an identifier of the LU. The I/F 8003 is the connection destination FC I/F of the LU. The capacity 8004 indicates the capacity of the LU.

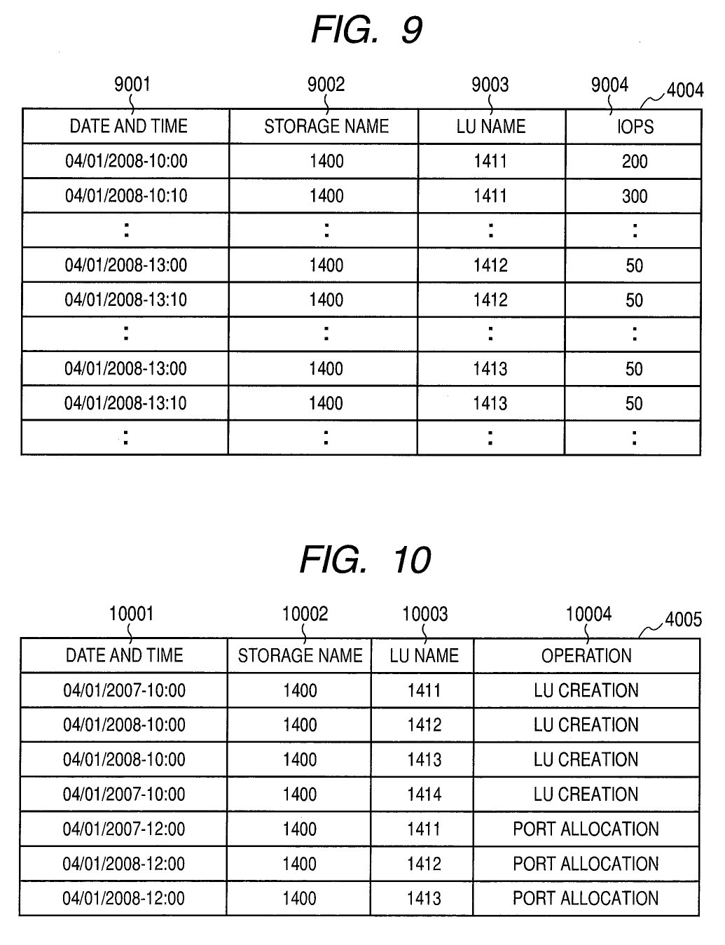

FIG. 9 shows the configuration of the storage device operating information table 4004. The storage device operating information table 4004 has a date and time 9001, a storage name 9002, an LU name 9003, and an IOPS 9004.

The date and time 9001 is the date and time at which operation information is acquired. The storage name 9002 is an identifier of the storage device. The LU name 9003 is an identifier of the LU. The IOPS 9004 is an amount of inputs/outputs per second that the LU receives.

FIG. 10 shows the configuration of the storage device configuration history table 4005. The storage device configuration history table 4005 has a date and time 10001, a storage name 10002 that is an identifier of the storage device, an LU name 10003 that is an identifier of the LU, and an operation 10004 that is operation contents for the storage device.

The date and time 10001 is the date and time at which the LU is created or the port is allocated to the LU. The storage name 10002 is an identifier of the storage device. The LU name 10003 is an identifier of the LU. The operation 10004 is operation contents for the storage device such as LU creation or the allocation of the port to the LU.

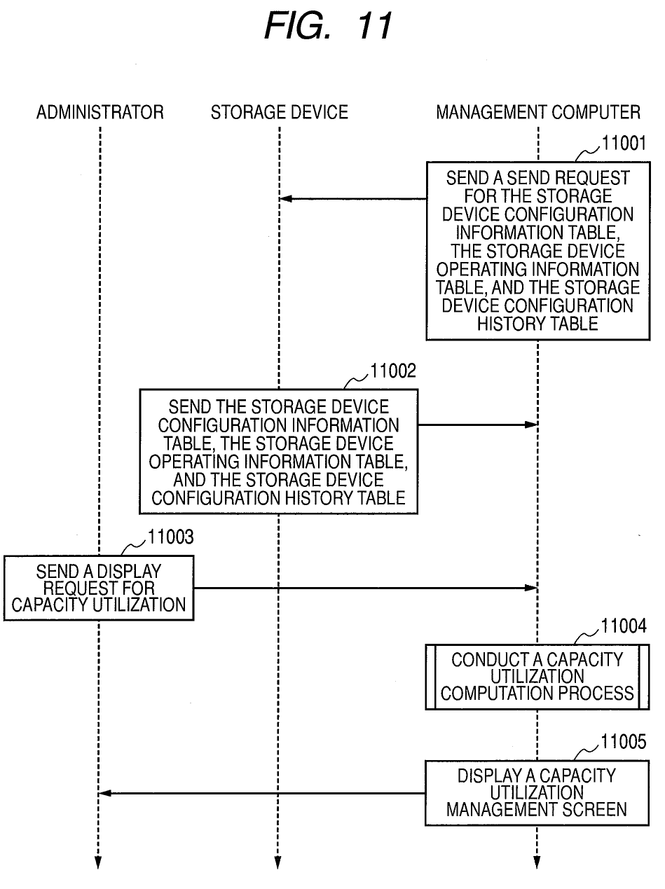

FIG. 11 shows a process flow of the capacity determination process. The CPU 1102 of the management computer 1100 performs the capacity determination program 3001. The capacity determination program 3001 is performed, and then the CPU 1102 sends a send request to the storage device 1400 for the storage device configuration information table 4003, the storage device operating information table 4004, and the storage device configuration history table 4005 (Step 11001).

The storage device 1400 receives the send request from the management computer 1100, and then the CPU 1403 of the storage device 1400 performs the storage device information management program 4002. The storage device information management program 4002 is performed, and then the CPU 1403 sends the storage device configuration information table 4003, the storage device operating information table 4004, and the storage device configuration history table 4005 to the management computer 1100 (Step 11002). The timing of sending may be the timing at which the send request is received from the management computer 1100, or at regular time intervals, or the timing at which the storage device configuration information table 4003 or the storage device operating information table 4004 is changed.

An administrator of the computer 1000 or the storage device 1400 sends a display request to the management computer 1100 for capacity utilization (Step 11003). The CPU 1102 of the management computer 1100 receives the request, performs a capacity utilization computation process (Step 11004), and sends to the management computer 1100 a capacity utilization management screen on which capacity utilization is displayed (Step 11005). The display request for capacity utilization sent from the administrator (Step 11003) may be sent from on the management computer, or may be sent from another computer.

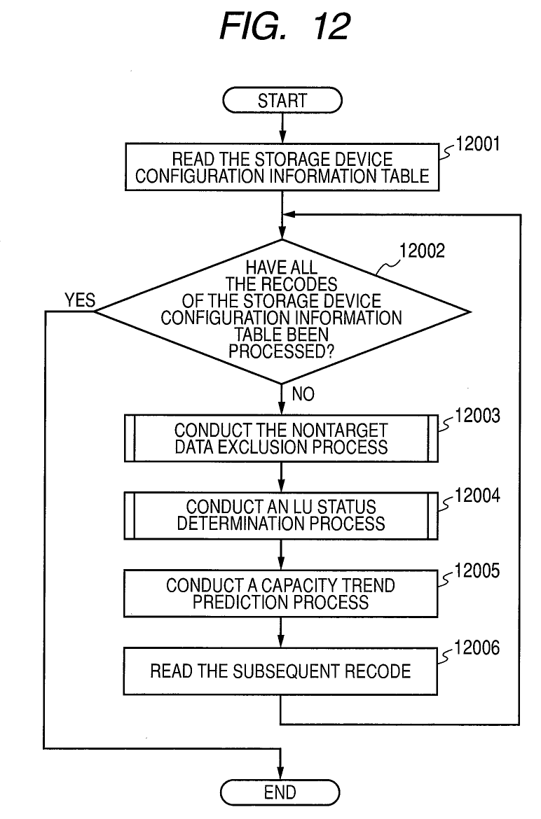

FIG. 12 shows a process flow of the capacity utilization computation process. The CPU 1102 of the management computer 1100 performs the capacity determination program 3001. The capacity determination program 3001 is performed, and then the CPU 1102 reads the storage device configuration information table 4003 to select the first record (Step 12001). In FIG. 8, the first record shows that the storage name 8001 is “1400”, the LU name 8002 is “1411”, the connection destination I/F 8003 is “1401”, and the capacity 4003 is “100 GB”.

Subsequently, the CPU 1102 of the management computer 1100 determines whether all the records of the storage device configuration information table 4003 have been processed (Step 12002). If the determined result is true, the CPU 1102 ends the process. If the determined result is false, the CPU 1102 performs the nontarget data exclusion process (Step 12003).

Subsequently, the CPU 1102 of the management computer 1100 performs an LU status determination process (Step 12004). Then, the CPU 1102 performs a capacity trend prediction process (Step 12005). Subsequently, the CPU 1102 reads the subsequent record of the storage device operating information table 4004 (Step 12006). The capacity trend prediction process is the process that uses information of the LU status management table 3003 created by the LU status determination process to forecast a trend in a future capacity increase. More specifically, the CPU 1102 of the management computer 1100 acquires the LU name 7002 having both of the allocation 7003 and the use 7004 of the LU status management table 3003 being “True”. Subsequently, the CPU 1102 seeks the LU name 8002 that is the same as the LU name 7002 from the storage device configuration information table, and computes the capacity used by the computer from the capacity 8004 of the corresponding LU. Information about the computed capacity is accumulated to forecast a trend in a future capacity increase. In the embodiment, the computation of capacity trend is forecast according to a statistical technique such as trend analysis in accordance with regression analysis.

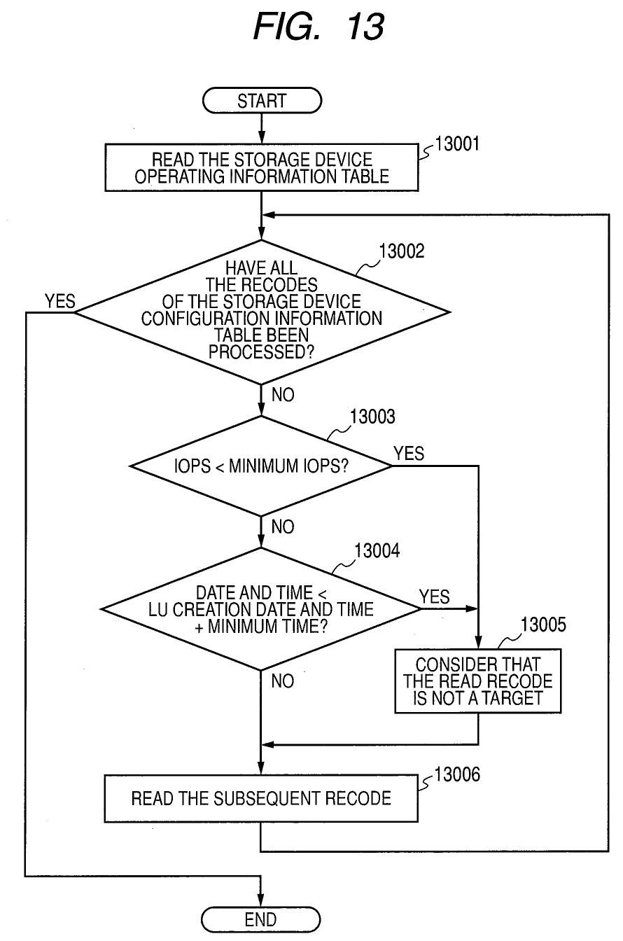

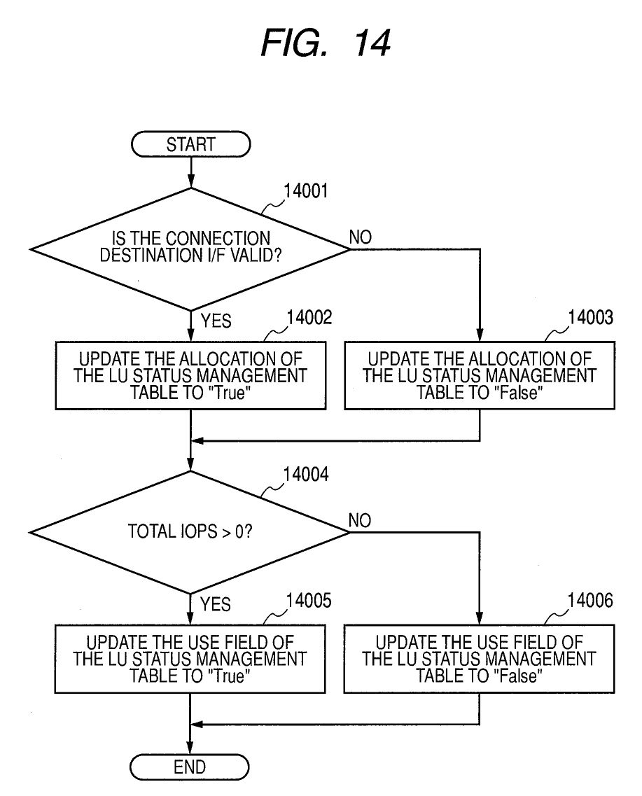

FIG. 13 shows a process flow of the nontarget data exclusion process. The nontarget data exclusion process compares the capacity determination configuration table 3002 with the storage device operation information table 4004, and excludes the LU that does not satisfy the conditions from the targets for the capacity utilization computation process. The nontarget data exclusion process is the process conducted to omit a certain amount of inputs/outputs generated by monitoring the server or the storage device itself. In addition, the nontarget data exclusion process is the process conducted to omit inputs/outputs in a certain period generated by data migration or formation after creation of the LU.

The CPU 1102 of the management computer 1100 reads the storage device operating information table 4004 to select the first record (Step 13001). In FIG. 9, the first record shows that the date and time 9001 is “2008/04/01-10:00”, the storage name 9002 is “1400”, the LU name 9003 is “1411”, and the IOPS 9004 is “200”.

Subsequently, the CPU 1102 of the management computer 1100 determines whether all the records have been processed (Step 13002). If the determined result is true, the CPU 1102 ends the process. If the determined result is false, the CPU 1102 performs the subsequent process (Step 13003). Subsequently, the CPU 1102 determines whether the IOPS 8004 of the storage device operating information table 4004 is smaller than the minimum IOPS of the capacity determination configuration table (Step 13003). If the determined result is true, the CPU 1102 considers that the read record is not a target for the capacity trend prediction process (Step 13005). If the determined result is false, the CPU 1102 performs the subsequent process (Step 13004). Subsequently, the CPU 1102 determines whether the date and time 8001 of the storage device operating information table 4004 is earlier than the time that the minimum time 6003 of the capacity determination configuration table 3002 is added to the date and time 10001 that the operation 10004 of the storage device configuration history table 4005 is LU creation (Step 13004). If the determined result is true, the CPU 1102 considers that the read record is not a target for the capacity trend prediction process (Step 13005). If the determined result is false, the CPU 1102 reads the subsequent record (Step 13006).

Step 13003 and Step 13004 may be performed in inverse order. In addition, any one of Step 13003 and Step 13004 may be performed.

FIG. 14 shows a process flow of the LU status determination process.

The LU status determination process is the process that determines whether the LU is allocated to the computer or not, and used by the computer or not. The LU that is not allocated to the computer and the LU that is allocated to the computer but not used by the computer are not targets for the capacity trend prediction process.

The capacity determination program 3001 refers to the selected record of the storage device configuration information table 4003, and determines whether the connection destination I/F 8003 is valid (Step 14001). When the connection destination I/F 8003 is valid, it indicates that the LU is allocated to the computer. If the determined result is true, the capacity determination program 3001 updates the allocation 6003 to “True”, which has the records that the storage name 6001 and the LU name 6002 of the LU status management table 3003 are the same as the storage name 7001 and the LU name 7002 of the storage device configuration information table 4003 (Step 14003). If the determined result is false, the capacity determination program 3001 updates the allocation 7003 to “False”, which has the records that the storage name 7001 and the LU name 7002 of the LU status management table 3003 are the same as the storage name 8001 and the LU name 8002 of the storage device configuration information table 4003 (Step 14003). Here, if there are not the same records in the LU status management table 3003 as the storage name 8001 and the LU name 8002 of the storage device configuration information table 4003, the records of the storage name 7001 and the LU name 7002 are added to the LU status management table 3003. The allocation 7003 may be another name, or may be configured of a plurality of fields.

Subsequently, the CPU 1102 of the management computer 1100 refers to the total value of the IOPSs 9004 of the storage device operating information table 4004 in which the storage name 9002 and the LU name 9003 are the same as the selected record of the storage name 8001 and the LU name 8002 of the storage device configuration information table 4003, and determines whether the total IOPS>0 (Step 14004). If the determined result is true, the CPU 1102 updates the use field 7004 to “True”, which has the records that the storage name 7001 and the LU name 7002 of the LU status management table 3003 are the same as the storage name 8001 and the LU name 8002 of the storage device configuration information table 4003 (Step 14005). This indicates that the LU is used by the computer. If the determined result is false, the CPU 1102 updates the use field 7004 to “False”, which has the records that the storage name 7001 and the LU name 7002 of the LU status management table 3003 are the same as the storage name 8001 and the LU name 8002 of the storage device configuration information table 4003 (Step 14006). This indicates that the LU is not used by the computer.

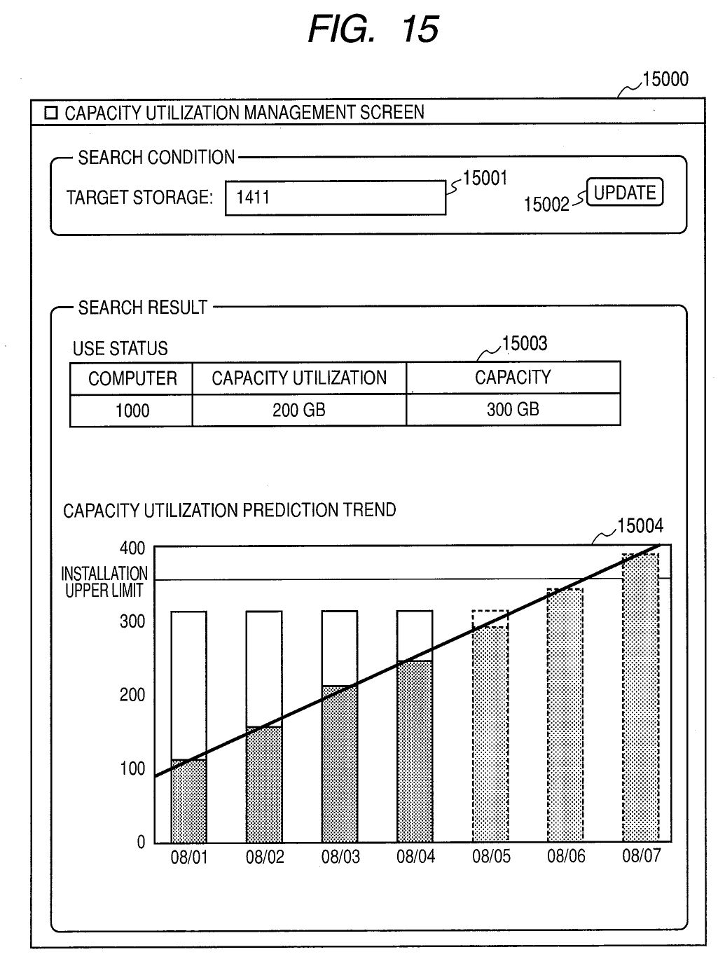

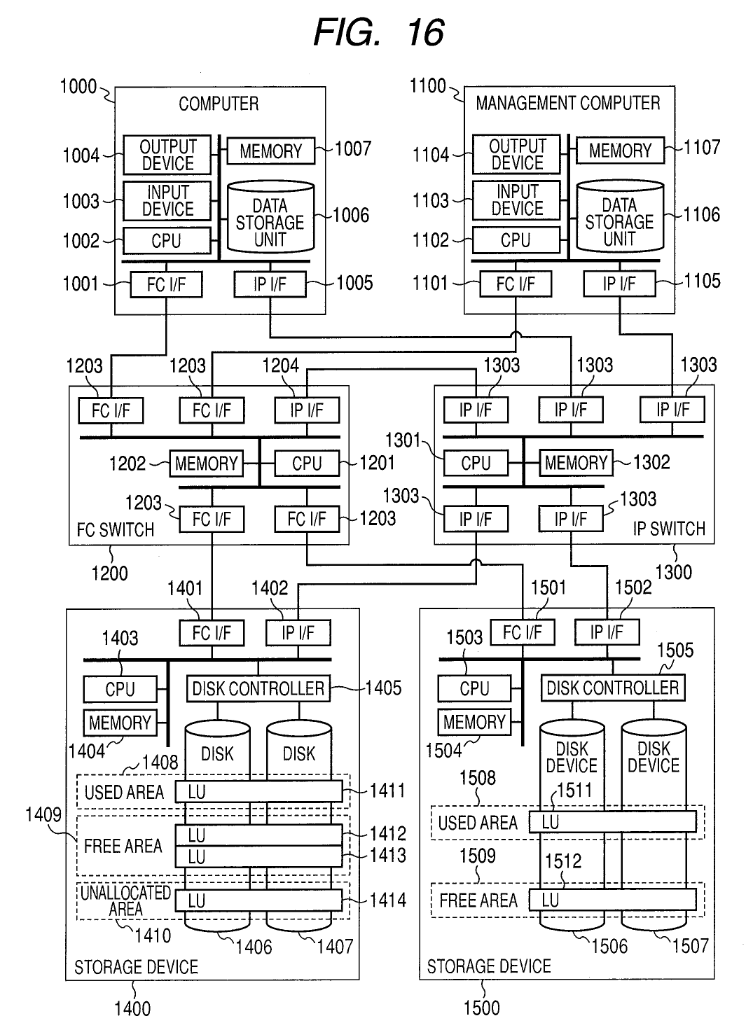

FIG. 15 shows the configuration of a capacity utilization management screen 15000. The capacity utilization management screen 15000 is displayed on the display device of the output unit 1104 of the management computer 1100. The capacity utilization management screen 15000 has a text box 15001 that enters a search target storage for capacity utilization, an update button 15002 that commands performing the capacity determination process to update the search result, a use status list 15003 that indicates the resulting current status acquired by pressing down the update button to perform the capacity determination process, and a capacity utilization prediction trend graph 15004 that indicates the future forecast result from the current use status. In the capacity utilization prediction trend graph 15004, an installation upper limit is the installation upper limit of disks determined by the hardware specifications of the storage device. The installation upper limit is compared with the capacity trend forecast from capacity utilization to know the timing of adding disks.

According to the embodiment, the disk capacity used by the computer can be managed with no installation of a program into the computer. In addition, also in the case in which there is a plurality of computers, or in the case in which the computer has a plurality of virtual file systems, program installation is unnecessary. On this account, loads applied to a server due to installation work or an agent program can be eliminated, and primary costs can be curtailed. In addition, a trend in a disk capacity increase is kept track of, whereby the timing of adding disks can be forecast.

### Embodiment 2

The outline of an embodiment of the invention is described. In the invention, by virtualization techniques, the LUs of a storage device 1400 used by a computer 1000 are the virtual LUs of a storage device 1500 that is externally connected. In the embodiment, when write occurs in the virtual LU of the storage device 1400, data is written in the real LU of the storage device 1500.

Hereinafter, the differences from embodiment 1 will be described.

FIG. 16 shows the system configuration in embodiment 2.

The storage device 1500 is a node that processes input/output data from the computer 1000. The storage device 1500 has an FC I/F 1501, an IP I/F 1502, a CPU 1503, a memory 1504, a disk controller 1505, disk devices 1506 and 1507, LUs 1511 and 1512, a used area 1508, and a free area 1509. The storage device 1400 has a virtual pool and a virtual LU in the virtual pool. In the virtual LU, the LU of the storage device 1500 is allocated.

A capacity determination process in embodiment 2 will be described.

A CPU 1102 of a management computer 1100 performs a capacity determination program 3001. The capacity determination program 3001 is performed, and then the CPU 1102 sends a send request to the storage device 1500 for a storage device configuration information table 4003, a storage device operating information table 4004, and a storage device configuration history table 4005.

The storage device 1500 receives the send request from the management computer 1100, and then CPU 1503 of the storage device 1500 performs the storage device information management program 4002. The storage device information management program 4002 is performed, and then the CPU 1403 sends to the management computer 1100 the storage device configuration information table 4003, the storage device operating information table 4004, and the storage device configuration history table 4005. The other steps are the same as those in embodiment 1.

The process flows of a capacity determination process, a capacity utilization computation process, and an LU status determination process are the same as those in embodiment 1.

According to the embodiment, because the disk capacity for each of the storage devices used by the computer can be managed with no installation of a program into the computer, loads applied to a server due to installation work or an agent program can be eliminated, and primary costs can be curtailed. In addition, physical disk capacity is compared with a trend in a disk capacity increase for each of the storage devices, whereby the timing of adding physical disks can be forecast for each of the storage devices.

### Embodiment 3

The outline of an embodiment of the invention will be described. In the invention, the programs and tables stored in the memory 1107 of the management computer 1100 in embodiment 1 are stored in a memory 1404 of a storage device 1400.

Hereinafter, the differences from embodiment 1 will be described.

The system configuration is the same as that of embodiment 1.

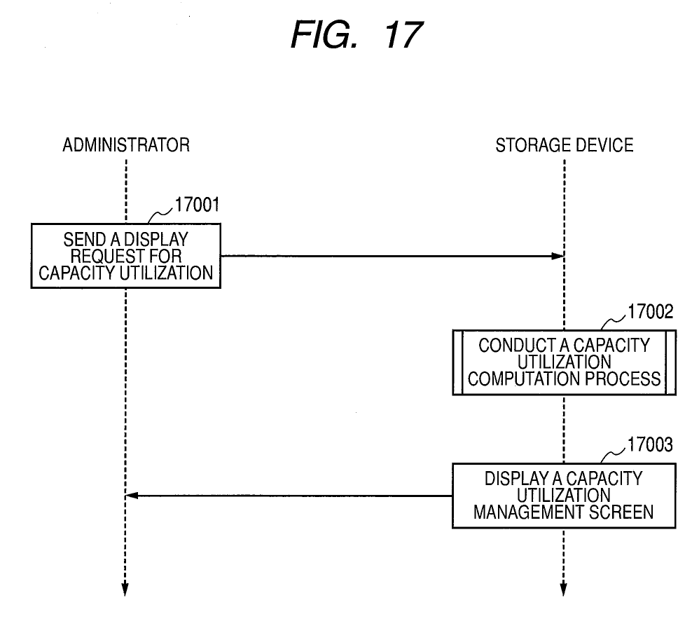

FIG. 17 shows a process flow of a capacity determination process. An administrator of a computer 1000 or the storage device 1400 sends a display request for capacity utilization to a management computer 1100 (Step 17001). The storage device receives the request, and then a CPU 1403 of the storage device 1400 performs a capacity utilization computation process (Step 17002). Subsequently, the CPU 1403 sends a capacity utilization management screen on which capacity utilization is displayed to the management computer 1100 (Step 17003). The display request for capacity utilization sent from the administrator (Step 17001) may be sent from on the management computer, or may be sent from another computer.

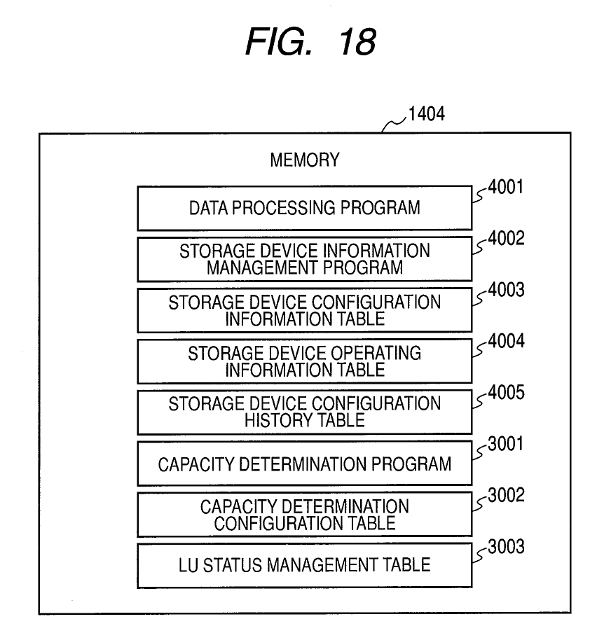

FIG. 18 shows the memory configuration of the storage device 1400. The storage device 1400 reads a data processing program 4001, a storage device information management program 4002, a storage device configuration information table 4003, a storage device operating information table 4004, a storage device configuration history table 4005, a capacity determination program 3001, a capacity determination configuration table 3002, and an LU status management table 3003 to a memory 1404 when started.

In the capacity utilization computation process, the nontarget data exclusion process, and the LU status determination process, the CPU 1403 of the storage device 1400 performs and processes the capacity determination program 3001.

According to the embodiment, the disk capacity used by the computer can be managed without sending configuration information and operating information to the management computer. On this account, the transfer rate between the storage device and the management computer can be reduced.

In addition, in embodiments 1 to 3, the data storage unit and the disk are a HDD (Hard Disk Drive) or a SSD (Solid State Disk), for example. In addition, in the case in which iSCSI is used, the FC I/F and the FC switch may be unnecessary.

In addition, in embodiments 1 to 3, the computer 1000 may be plural, or the computer 1000 may have a plurality of virtual file systems.

What is claimed is:

1. A computer system comprising:
a first computer;
a second computer; and
a storage device connected to the first computer and the second computer,
wherein the storage device creates a plurality of logical units, the logical unit storing therein data sent from the first computer, manages information whether an input/output request is made from the first computer to the plurality of the logical units, and sends to the second computer the information whether the input/output request is made, and
the second computer receives the information whether the input/output request is made from the storage device, determines that a logical unit to which the input/output request is made is used by the first computer, and computes a capacity of the storage device used by the first computer from a capacity of the used logical unit.

2. The computer system according to claim 1,
wherein the first computer has a plurality of virtual file systems, and
in the plurality of the virtual file systems, the capacity of the used logical unit is managed for each of the virtual file systems.

3. The computer system according to claim 2,
wherein the second computer determines that the logical unit is used when a count of the input/output requests to the logical unit exceeds a certain count.

4. The computer system according to claim 3,
wherein the second computer determines that the logical unit is used when a certain time period has elapsed after creation of the logical units.

5. The computer system according to claim 4,
wherein the second computer determines that the logical unit is allocated to the first computer when the logical unit is connected to a port of the storage device, and determines that the logical unit is used by the first computer when a count of the input/output requests from the first computer to the logical unit is greater than zero.

6. The computer system according to claim 5,
wherein the second computer computes a capacity of the storage device used by the first computer, computes a trend in a future capacity increase from the computed capacity, and displays the storage device, the capacity, and a trend in an increase in the capacity on a screen of the second computer.

7. The computer system according to claim 1,
wherein a second storage device is connected to the first computer, the second computer, and a first storage device,
the first storage device creates a plurality of first logical units, the first logical unit storing therein data sent from the first computer,
the second storage device creates a plurality of second logical units, the second logical unit storing therein data sent from the first computer, and allocates the plurality of the second logical units to the first computer as the logical units of the first storage device,
the first storage device manages information whether an input/output request is made from the first computer to the plurality of the second logical units, and sends to the second computer the information whether the input/output request is made, and
the second computer receives the information whether an input/output request is made from the first storage device to the plurality of the second logical units, determines that the second logical unit to which the input/output request is made is used by the first computer, and computes a capacity of the second storage device used by the first computer from a capacity of the used second logical unit.

8. The computer system according to claim 1,
wherein the storage device creates a plurality of logical units, the logical unit storing therein data sent from the first computer, manages information whether an input/output request is made from the first computer to the plurality of the logical units, determines that a logical unit to which the input/output request is made is used by the first computer, and computes a capacity of the storage device used by the first computer from a capacity of the used logical unit.

9. The computer system according to claim 1,
wherein there is a plurality of the first computers, and
the plurality of the first computers manage the capacity of the used logical unit for each of the first computers.

10. A capacity management method of a computer system having a first computer, a second computer, and a storage device connected to the first computer and the second computer,
wherein the storage device creates a plurality of logical units, the logical unit storing therein data sent from the first computer, manages information whether an input/output request is made from the first computer to the plurality of the logical units, and sends to the second computer the information whether the input/output request is made, and
the second computer receives the information whether the input/output request is made from the storage device, determines that a logical unit to which the input/output request is made is used by the first computer, and computes a capacity of the storage device used by the first computer from a capacity of the used logical unit.

11. The capacity management method of a computer system according to claim 10,
wherein the first computer has a plurality of virtual file systems, and
in the plurality of the virtual file systems, the capacity of the used logical unit is managed for each of the virtual file systems.

12. The capacity management method of a computer system according to claim 11,
wherein the second computer determines that the logical unit is used when a count of the input/output requests to the logical unit exceeds a certain count.

13. The capacity management method of a computer system according to claim 12,
wherein the second computer determines that the logical unit is used when a certain time period has elapsed after creation of the logical units.

14. The capacity management method of a computer system according to claim 13,
wherein the second computer determines that the logical unit is allocated to the first computer when the logical unit is connected to a port of the storage device, and determines that the logical unit is used by the first computer when a count of the input/output requests from the first computer to the logical unit is greater than zero.

15. The capacity management method of a computer system according to claim 14,
wherein the second computer computes a capacity of the storage device used by the first computer, computes a trend in a future capacity increase from the computed capacity, and displays the storage device, the capacity, and a trend in an increase in the capacity on a screen of the second computer.

16. The capacity management method of a computer system according to claim 10,
wherein a second storage device is connected to the first computer, the second computer, and a first storage device,
the first storage device creates a plurality of first logical units, the first logical unit storing therein data sent from the first computer,
the second storage device creates a plurality of second logical units, the second logical unit storing therein data sent from the first computer, and allocates the plurality of the second logical units to the first computer as the logical units of the first storage device,
the first storage device manages information whether an input/output request is made from the first computer to the plurality of the second logical units, and sends to the second computer the information whether the input/output request is made, and
the second computer receives the information whether an input/output request is made from the first storage device to the plurality of the second logical units, determines that the second logical unit to which the input/output request is made is used by the first computer, and computes a capacity of the second storage device used by the first computer from a capacity of the used second logical unit.

17. The capacity management method of a computer system according to claim 10,
wherein the storage device creates a plurality of logical units, the logical unit storing therein data sent from the first computer, manages information whether an input/output request is made from the first computer to the plurality of the logical units, determines that a logical unit to which the input/output request is made is used by the first computer, and computes a capacity of the storage device used by the first computer from a capacity of the used logical unit.

18. The capacity management method of a computer system according to claim 10,
wherein there is a plurality of the first computers, and
the plurality of the first computers manage the capacity of the used logical unit for each of the first computers.

19. A computer system comprising:
a first computer;
a second computer; and
a storage device connected to the first computer and the second computer,
wherein the storage device creates a plurality of logical units, the logical unit storing therein data sent from the first computer, manages information whether an input/output request is made from the first computer to the plurality of the logical units, and sends to the second computer items of information about a capacity of the plurality of the logical units, a count of input/output requests to the plurality of the logical units, a date and time at which the input/output request is made, and a date and time at which the plurality of the logical units is created and the information whether the input/output request is made, and
the second computer keeps minimum inputs/outputs and a minimum time in order to determine whether the first computer uses the plurality of the logical units, at a time at which the second computer receives a request to display capacity utilization from the first computer, the second computer determines that the logical units are used by the first computer when a count of input/output requests to the logical unit exceeds the minimum inputs/outputs, the minimum time is exceeded after creation of the logical units and an input/output request is made to the logical unit, the second computer computes a capacity of the storage device used by the first computer from a capacity of the used logical units, computes a trend in a future capacity increase from the computed capacity, and displays the computed capacity and a trend in an increase in the computed capacity on a screen of the second computer.
